(19) United States
(12) Patent Application Publication
(10) Pub. No.: US 2008/0132642 A1
(43) Pub. Date: Jun. 5, 2008

(54) Process for Manufacturing a Thermoplastic Elastomeric Material

(76) Inventors: Serena Coiai, Pontasserchio (PI) (IT); Francesco Ciardelli, Pisa (IT); Elisa Passaglia, Pisa (IT); Roberta Sulcis, Volterra (PI) (IT); Emilano Resmini, Milano (IT); Diego Tirelli, Milano (IT); Franco Peruzzotti, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/792,315

(22) PCT Filed: Dec. 16, 2004
(86) PCT No.: PCT/EP04/14313

§ 371 Date: Jun. 5, 2007

(51) Int. Cl. C08L 9/02; C08L 9/06

(52) U.S. Cl. 525/86

(57) ABSTRACT

A process for manufacturing a thermoplastic elastomeric material includes the following steps: surface treating a vulcanized rubber in a subdivided form in order to provide radically transferable atoms or groups on its surface; grafting at least one vinyl monomer to the surface treated vulcanized rubber in the presence of at least one transition metal compound and at least one ligand so as to obtain a vinyl polymer grafted onto the surface of the vulcanized rubber in a subdivided form.

The present invention relates to a process for manufacturing a thermoplastic elastomeric material.

In particular, the present invention relates to a process for manufacturing a thermoplastic elastomeric material, said process comprising an atom transfer radical polymerization (ATRP) of vinyl monomers in the presence of a vulcanized rubber in a subdivided form, so as to a thermoplastic elastomeric material so obtained.

In a further aspect, the present invention also relates to a manufactured product including said thermoplastic elastomeric material.

The increased production of industrial rubber products has resulted in the accumulation of large amounts of rubber wastes which are generally disposed in dedicated landfills with the main drawbacks of environment pollution as well as of the need for large dedicated areas for storing said wastes.

It is known in the art to depolymerize waste rubber, such as tyres, in an effort to reduce the volume of waste and obtain a useful byproduct. Likewise, rubber products may be devulcanized in an attempt to recycle the waste rubber.

In addition to these techniques, it is common in the art to grind the waste rubber and utilize the ground particles so obtained. These ground particles may then be compounded with thermoplastic polymeric materials in order to make final products which may be employed in a plurality of applications.

Said ground particles may be added to substantially thermoplastic polymers such as, for example, polypropylene or polystyrene, to improve their impact strength.

For example, the article of D. Tuchman and S. L. Rosen published in “Journal of Elastomers and Plastics”, Vol. 10, pp. 115-128 (1978), discloses the addition of cryogenically ground tyre rubber to various thermoplastic polymers including polypropylene and polystyrene. In particular, with regard to polystyrene, the authors said that the cryogenically ground tyre rubber acts as a moderately good impact enhancer when mechanically blended with polystyrene. A mechanical blend comprising 20% by weight of cryogenically ground tyre rubber produces a material mechanically comparable to a medium impact polystyrene. Moreover, the authors have investigated several techniques in order to graft styrene to the cryogenically ground tyre rubber. To this aim, different techniques were investigated such as, bulk graft, free radical graft and acid graft. The authors said that only an aqueous slurry process using a water-soluble initiator system was successful in giving a product having improved impact strength with respect to a product obtained by a straight mechanical blend.

U.S. Pat. No. 3,042,634 discloses a process of making a rubber-resin product which comprises heating a mixture comprising comminuted rubber that has been vulcanized, water and resin-forming monomeric material selected from the group consisting of monoolefins such as, for example, styrene, α-methyl styrene, and acrylonitrile, and mixtures of such monoolefins, with material selected from the group consisting of butadiene and divinyl benzene, in an amount up to one-fourth the weight of said monoolefins, at a temperature of from 125° C. to 250° C., until polymerization of said monomeric material, and recovering a dry-rubber resin product therefrom that may be masticated to give a uniform smooth rubber-resin blend. The abovementioned rubber-resin product is said to range from a stiffened rubbery product at the lower styrene monomer charge to a rigid brittle gum plastic at high styrene monomer charge.

Patent application GB 2,022,105 discloses a method of making plastic materials incorporating reclaimed tyre rubber which comprises swelling said reclaimed tyre rubber with a quantity of monomer which is insufficient to saturate said reclaimed tyre rubber and polymerizing the swollen mass. Monomers which may be conveniently used are selected from: vinyl aromatic compounds such as, for example, styrene, or substituted styrenes (for example, β-bromostyrene, chlorostyrene); acrylonitrile; divinyl benzene; or mixtures thereof. The obtained plastic materials are said to have good impact strength, tensile strength and elongation at break.

The article of M. Pittolo and R. P. Burford published in “Journal of Material Science”, Vol. 21, pp. 1769-1774 (1986), discloses a study on rubber-crumb modified polystyrene. In particular, peroxide crosslinked polybutadiene and styrene/butadiene rubber powders were converted to semi-interpenetrating networks by swelling in styrene monomer and subsequent homopolymerization. Two initiator types were selected, one causing bonding between polystyrene and the rubber (benzoyl peroxide), the other allowing independent polymerization [azobis(isobutyro-nitrile)]. The polystyrene modified powders were then incorporated into a polystyrene matrix and the tensile properties of the resulting composites were determined. Improvements in performance over untreated crumb-modified composites were observed, with increased breaking strains due to crazing.

The article of M. Pittolo and R. P. Burford published in “Rubber Chemistry and Technology”, Vol. 58, pp. 97-106 (1986), discloses the use of recycled rubber-crumb as toughener of polystyrene. In particular, the rubber-crumb were treated with styrene monomer and benzoyl peroxide in order to graft the polystyrene on the rubber-crumb surface. The obtained modified rubber-crumb was then incorporated into a polystyrene matrix obtaining a composite material. The toughness of the obtained composite material is said to increase with increasing rubber-to-matrix adhesion and decreasing particle size of the rubber-crumb.

The paper “Free radical polymerization of vinyl monomers in the presence of ground tyre rubber” presented by S. Coiai et al. at the NATO School conference “Macromolecules 2003” held at Tirrenia (Pisa), Italy, on 6-16 Oct., 2003, discloses the possibility of providing some transfer groups onto the ground rubber surface in order to increase the grafted polymer content. No mention is made about the type of transfer groups which may be advantageously used.

The Applicant has faced the problem of improving the impact strength of thermoplastic elastomeric materials incorporating vulcanized ground rubber. In particular, the Applicant has faced the problem of improving the impact strength of thermoplastic elastomeric materials comprising a vulcanized ground rubber surface-grafted with at least one vinyl polymer.

The Applicant has now found that it is possible to improve said impact strength by increasing the amount of said surface-grafted vinyl polymer. In particular, the Applicant has now found that it is possible to increase the amount of said surface-grafted vinyl polymer by means of a process comprising an atom transfer radical polymerization (ATPR) of vinyl monomers in the presence of a vulcanized ground rubber. Said process allows to obtain thermoplastic elastomeric materials showing an improved impact strength which may be directly used in order to make manufactured products. Moreover, said thermoplastic elastomeric materials may be used in blends with other polymeric materials, in particular with polymeric materials having the same kind of polymeric chains (e.g. vinyl polymer chains), in order to improve their impact strength.

According to a first aspect, the present invention relates to a process for manufacturing a thermoplastic elastomeric material, said process comprising the following steps:
surface treating a vulcanized rubber in a subdivided form in order to provide radically transferable atoms or groups on its surface;
grafting at least one vinyl monomer to said surface-treated vulcanized rubber in the presence of at least one transition metal compound and at least one ligand so as to obtain a vinyl polymer grafted onto the surface of said vulcanized rubber in a subdivided form.

According to one preferred embodiment, the grafting efficiency (Φ) of said vinyl polymer onto the surface of said vulcanized rubber is not lower than 40%, preferably of from 45% to 60%, more preferably of from 50% to 80%.

Said grafting efficiency (Φ) may determined by the means of the following formula:

$$( Φ ) = \frac{( WGV )}{( WTV )} \times 100$$

wherein:
WGV is the weight, expressed in grams (g), of the surface-grafted vinyl polymer;
WTV is the total weight, expressed in grams (g), of the vinyl polymer contained in the obtained thermoplastic elastomeric material.

The weight of the surface-grafted vinyl polymer may be determined by means of gravimetric analysis by mass balance: further details about said analysis will be reported in the examples which follow.

For the aim of the present description and of the claims which follow, with the expression “the total weight of the vinyl polymer contained in the obtained thermoplastic elastomeric material” it is intended the sum between the weight of the surface-grafted vinyl polymer and the weight of the ungrafted vinyl polymer present in the obtained thermoplastic elastomeric material. Said weight may be determined by means of a gravimetric analysis by mass balance: further details about said analysis will be reported in the examples which follow.

According to a further preferred embodiment, the Degree of Grafting (DG) (%) of said vinyl polymer onto the surface of said vulcanized rubber in a subdivided form is not lower than 150%, preferably of from 160% to 600%, more preferably of from 180% to 800%.

The Degree of Grafting (DG) may be determined according to the article of M. Pittolo and R. P. Burford published in “Rubber Chemistry and Technology,” above reported, by means of the following formula:

$$\% DG = \frac{( WAE - WRS )}{( WRS )} \times 100$$

wherein:
WAE is the weight, expressed in grams (g), of the obtained thermoplastic elastomeric material after extraction of the ungrafted vinyl polymer;
WRS is the weight, expressed in grams (g), of the vulcanized rubber in a subdivided form in the obtained thermoplastic elastomeric material.

Further details about the determination of the Degree of Grafting will be reported in the examples which follow.

According to a further preferred embodiment, said vinyl polymer is grafted onto the surface of said vulcanized rubber in a subdivided form in an amount not lower than 60% by weight, more preferably not lower than 70% by weight, with respect to the total weight of the surface-grafted vinyl polymer and the vulcanized rubber in a subdivided form.

Generally, said amount is not higher than 99.9% by weight, preferably not higher than 95% by weight, with respect to the total weight of the surface-grafted vinyl polymer and the vulcanized rubber in a subdivided form.

The amount of the vinyl polymer grafted onto the surface of said vulcanized rubber in a subdivided form may be determined by means of the following formula:

$$\% of surface \text{-} grafted vinyl polymer = \frac{( WGV )}{( WAE )} \times 100$$

wherein:
WGV is the weight, expressed in grams (g), of the surface-grafted vinyl polymer;
WAE is the weight, expressed in grams (g), of the obtained thermoplastic elastomeric material after extraction of the ungrafted vinyl polymer.

The extraction of the ungrafted vinyl polymer may be carried out by means of processes known in the art such as, for example, by solvent extraction: further details about the extraction process will be reported in the examples which follow.

According to a further aspect, the present invention also relates to a thermoplastic elastomeric material comprising a vulcanized rubber in a subdivided form surface-grafted with at least one vinyl polymer obtainable by means of the process above disclosed.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

The vulcanized rubber in a subdivided form which is used in the present invention may be obtained by grinding or otherwise comminuting any source of vulcanized rubber compound such as, for example, tyres, roofing membranes, hoses, gaskets, and the like, and is preferably obtained from reclaimed or scrap tyres using any conventional method. For example, the vulcanized rubber in a subdivided form may be obtained by mechanical grinding at ambient temperature or in the presence of a cryogenic coolant (i.e. liquid nitrogen). Any steel or other metallic inclusions should be removed from the ground tyres before use. Usually, fibrous material such as, for example, tyre cord fibers, is preferably removed from the ground rubber using conventional separation methods.

According to one preferred embodiment, the vulcanized rubber in a subdivided form which may be used in the present invention, is in the form of powder or granules having a particle size not higher than 10 mm, preferably not higher than 5 mm.

According to a more preferred embodiment, the vulcanized rubber in a subdivided form which may be used in the present invention, has a particle size not higher than 0.5 mm, preferably not higher than 0.2 mm, more preferably not higher than 0.1 mm.

According to one preferred embodiment, the vulcanized rubber in a subdivided form may comprise at least one crosslinked diene elastomeric polymer or copolymer which may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the crosslinked diene elastomeric polymer or copolymer may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

Alternatively, the vulcanized rubber in a subdivided form may further comprise at least one crosslinked elastomeric polymer of one or more monoolefins with an olefinic comonomer or derivatives thereof. The monoolefins may be selected, for example, from: ethylene and α-olefins generally containing from 3 to 12 carbon atoms such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

The above reported step of surface treating a vulcanized rubber in a subdivided form in order to provide radically transferable atoms or groups on its surface may be carried as follows.

For example, said step may be carried by dispersing said vulcanized rubber in a subdivided form in a mixture comprising at least one organic solvent, at least one tertiary amine and at least one compound having the following structural formula (I):

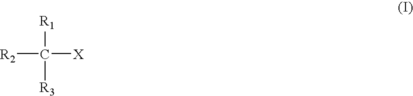

wherein:
X represents a halogen atom such as, for example, chlorine, bromine, iodine, or fluorine; a OR₄ group wherein R₄ represents a linear or branched C₁-C₂₀ alkyl group, a linear or branched C₂-C₂₀ alkenyl group, a linear or branched C₂-C₁₀ alkynyl group, a phenyl group, said phenyl group being optionally substituted by 1 to 5 halogen atoms or by 1 to 5 linear or branched C₁-C₄ alkyl groups; a group selected from: SR₅, SeR₅, C(═O)R₅, OP(═O)R₅, OP(═O) (OR₅)₂, OP(═O)OR₅, O—N(R₅)₂, wherein R₅ represents a C₆-C₁₈ aryl group; a C₇-C₂₀ arylalkyl or alkylaryl group such as, for example, methylphenyl, ethylphenyl, phenylethyl; a C₇-C₂₀ arylalkoxy or alkoxyaryl group; a linear or branched C₁-C₂₀ alkyl group; a N(R₄)₂ group wherein the two R₄ groups considered jointly with the nitrogen atom to which they are linked, represent a C₅-C₁₈ heterocyclic ring;
R₁, R₂ and R₃, which may be identical or different, represent a hydrogen atom; a linear or branched C₁-C₂₀ alkyl group; a C₃-C₈ cycloalkyl group; a C(═Y)R₆ group wherein Y represents an oxygen atom or a NR₉ group wherein R₉ represents a linear or branched C₁-C₂₀ alkyl group, a C₇-C₂₀ arylalkyl or alkylaryl group and R₉ represents a linear or branched C₁-C₂₀ alkyl group, a linear or branched C₁-C₂₀ alkoxy group, a C₇-C₂₀ arylalkoxy or alkoxyaryl group, a heterocyclyloxy group; a halogen atom such as, for example, chlorine, bromine, iodine, or fluorine; or a C═(Y)NR₇R₈ group wherein Y has the same meanings reported above and R₇ and R₈, which may be identical or different, represent a hydrogen atom, a linear or branched C₁-C₂₀ alkyl group, or R₇ and R₈ groups considered jointly with the nitrogen atom to which they are linked, represent a C₅-C₁₈ heterocyclic ring; a linear or branched C₂-C₂₀ alkenyl or alkynyl group; a oxiranyl group; a glycydyl group; a C₆-C₁₈ aryl group; a C₇-C₂₀ arylalkyl or alkylaryl group.

Preferably, X is a chlorine atom or a bromine atom, more preferably is a bromine atom; R₁ is a C(═Y)R₆ group wherein Y is an oxygen atom and R₆ is a bromine atom or a linear or branched C₁-C₂₀ alkoxy group, more preferably an ethoxy group; R₂ and R₃, which may be identical or different, are a linear or branched C₁-C₂₀ alkyl group, preferably a methyl group.

Specific examples of compound having structural formula (I) which may be advantageously used in the present invention are: 1-phenylethylchloride, 1-phenylethylbromide, methyl 2-chloropropionate, ethyl 2-chloropropionate, methyl 2-bromopropionate, ethyl 2-bromoisobutyrate, α,α′-dichloroxylene, α,α′-dibromoxylene, hexakis(α-bromomethyl)benzene, 2-bromoisobutyryl bromide, ethyl-2-bromopropionate, or mixture thereof. 2-Bromoisobutyryl bromide or ethyl-2-bromopropionate are particularly preferred.

Preferably, the organic solvent may be selected, for example, from: ketones such as, for example, acetone; alcohols such as, for example, ethanol, methanol; ethers such as, for example, tetrahydrofurane, dioxane, diethyl ether; or mixtures thereof.

Preferably, the tertiary amine, which may act as a reaction catalyst, may be selected, for example, from: trimethylamine, triethylamine, tripropylamine, ethyleneimine, pyrrolidine, N,N-dimethylaminepyridine, or mixtures thereof. Triethylamine is particularly preferred.

Preferably, the compound having structural formula (I) may be used in an amount of from 0.1 ml to 10 ml, preferably of from 1 ml to 5 ml, with respect to 1 g of the vulcanized rubber in a subdivided form.

Preferably, the solvent may be used in an amount of from 10 ml to 100 ml, preferably of from 40 ml to 70 ml, with respect to 1 g of the vulcanized rubber in a subdivided form.

Preferably, the tertiary amine may be used in an amount of from 1 ml to 10 ml, preferably of from 3 ml to 7 ml, with respect to 1 g of the vulcanized rubber in a subdivided form.

Preferably, the surface treating step may be carried out at a temperature of from 40° C. to 120° C., more preferably of from 60° C. to 100° C., for a time of from 1 hour to 24 hours, more preferably of from 5 hours to 15 hours.

According to one preferred embodiment, the vulcanized rubber in a subdivided form may be subjected, before providing a radically transferable atoms or groups on its surface, to an additional surface treating step in order to provide hydroxy groups and/or mercapto groups on its surface. Said additional surface treating step may be carried out in different ways.

For example, the step of surface treating a vulcanized rubber in a subdivided form in order to provide hydroxy groups on its surface, may be carried out by dispersing said vulcanized rubber in a subdivided form in a mixture comprising water and an organic solvent with at least one oxidizing agent.

Preferably, the organic solvent may be selected, for example, from: ketones such as, for example, acetone; alcohols such as, for example, ethanol, methanol; ethers such as, for example, tetrahydrofurane, dioxane; or mixtures thereof. Acetone aqueous solution (10% acetone/90% water) is particularly preferred.

Preferably, the oxidizing agent may be selected, for example from: potassium permanganate, hydrogen peroxide, osmium tetraoxide, hydrogen peroxide/urea complex, sodium percarbonate, sodium perchlorate, sodium perborate, potassium peroxymonosulfate, potassium permanganate/potassium periodate aqueous solution, or mixtures thereof. Potassium permanganate is particularly preferred.

Preferably, said surface treating step may be carried out at a temperature of from −15° C. to 50° C., more preferably of from 0° C. to 30° C., for a time of from 1 hour to 48 hours, more preferably of from 18 hours to 30 hours.

Preferably, the oxidizing agent is used in an amount of from 1% by weight to 50% by weight, preferably of from 10% by weight to 25% by weight, with respect to the total weight of the vulcanized rubber in a subdivided form.

Alternatively, the step of surface treating a vulcanized rubber in a subdivided form in order to provide hydroxy groups on its surface, may be carried out by reacting the said vulcanized rubber in a subdivided form with a thio-glycerol having the following structural formula (II):

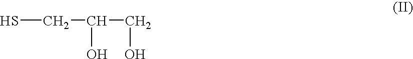

in the presence of at least one free radical initiator.

Preferably, the thio-glycerol may be used in an amount of from 0.01% by weight to 3% by weight, preferably of from 0.1% by weight to 1% by weight, with respect to the total weight of the vulcanized rubber in a subdivided form.

Preferably, the free radical initiator may be selected from azo compounds having the following structural formula (III):

R′₂—N═N—R′₃ (III)

wherein R′₂ and R′₃, which may be identical or different, may be selected from organic groups such as, for example, aliphatic, cycloaliphatic, or aromatic groups; or linear or cyclic nitrile derivatives.

Preferably, the free radical initiator may be selected, for example, from: 1,1′-azobis(cyclohexane-carbonitrile), azodicarbonamide, 2,2′-azobis(2,4-dimethyl-pentenenitrile), 2,2′-azobis(2-ethylpropanimide-amide).2HCl, 2,2′-azobis(isobutyronitrile), 2,2′-azobis(2-methylbutanenitrile), 4,4′-azobis(4-cyanopentanoic acid), 2,2′-azobis(2-acetoxypropane), 2-(t-butylazo)-4-methoxy-2,4-dimethylpentanenitrile, 2-(t-butylazo)-2,4-dimethyl-pentanenitrile, 4-(t-butylazo)-4-cyanopentanoic acid, 2-(t-butylazo)isobutyronitrile, 2-(t-butylazo)-2-methyl-butanenitrile, 1-(t-amylazo)cyclohexanecarbonitrile, 1-(t-butylazo)cyclohexanecarbonitrile, 1-(t-butylazo)formamide, or mixtures thereof. 2,2′-Azobis(isobutyronitrile) is particularly preferred.

Preferably, the free radical initiator may be used in an amount of from 0.001% by weight to 10% by weight, preferably of from 0.005% by weight to 5% by weight, with respect to the total weight of the vulcanized rubber in a subdivided form.

Preferably, the reaction with a thio-glycerol and at least one free radical initiator may be carried out at a temperature of from 0° C. to 150° C., more preferably of from 30° C. to 90° C., for a time of from 1 hour to 75 hours, more preferably of from 30 hours to 50 hours.

The step of surface treating a vulcanized rubber in a subdivided form in order to provide mercapto groups on its surface may be carried out as follows.

For example, the vulcanized rubber surface-treated as above disclosed in order to provide hydroxy groups on its surface, may be reacted with at least one silane coupling agent in order to provide mercapto groups on its surface.

Preferably, the silane coupling agent may be selected, for example, from compounds having the following structural formula (IV):

(R′)₃Si—CₙH₂ₙ—SH (IV)

wherein the groups R′, which may be identical or different, are selected from: alkyl, alkoxy or aryloxy groups or from halogen atoms, on condition that at least one of the groups R is an alkoxy or aryloxy group; n is an integer of from 1 to 6 inclusive.

Preferably, the coupling agents may be selected, for example, from: (3-mercaptopropyl)trimetoxysilane, (3-mercaptopropyl)dimetoxymethylsilane, (3-mercaptopropyl)-trietoxysilane, (3-mercaptopropyl)dietoxymethylsilane, (3-mercaptopropyl)metoxydimethylsilane, (4-mercaptobutyl)-trimetoxysilane, (4-mercaptobutyl)dietoxymethylsilane, or mixtures thereof. (3-Mercaptopropyl)trimetoxysilane is particularly preferred.

Preferably, the reaction with at least one coupling agent may be carried out at a temperature of from −10° C. to 150° C., more preferably of from 80° C. to 100° C., for a time of from 1 hour to 48 hours, more preferably of from 18 hours to 30 hours.

Preferably, the coupling agent may be used in an amount of from 0.01% by weight to 10% by weight, preferably of from 0.8% by weight to 2% by weight, with respect to the total weight of the surface-treated vulcanized rubber.

Alternatively, the mercapto groups may be provided on the surface of the vulcanized rubber in a subdivided form by reacting the same with at least one thio-acid having the following structural formula (V):

R′₁—C(═O)—SH (V)

wherein R′₁ is selected from alkyl, aryl, alkylaryl or arylakyl groups, in the presence of at least one free radical initiator.

Preferably, the thio-acid may be selected, for example, from: thioacetic acid, thiopropionic acid, thiobenzoic acid, or mixtures thereof. Thioacetic acid is particularly preferred.

Preferably, the thio-acid may be used in an amount of from 0.01% by weight to 3% by weight, preferably of from 0.1% by weight to 1% by weight, with respect to the total weight of the vulcanized rubber in a subdivided form.

Preferably, the free radical initiator may be selected from azo compounds having the structural formula (III) above reported, or mixtures thereof. 2,2′-Azobis(isobutyronitrile) is particularly preferred.

Preferably, the free radical initiator may be used in an amount of from 0.001% by weight to 10% by weight, preferably of from 0.005% by weight to 5% by weight, with respect to the total weight of the vulcanized rubber in a subdivided form.

Preferably, the reaction with at least one thio-acid and at least one free radical initiator may be carried out at a temperature of from 0° C. to 150° C., more preferably of from 30° C. to 90° C., for a time of from 1 hour to 75 hours, more preferably of from 30 hours to 50 hours.

According to one preferred embodiment, the vinyl monomer may be selected, for example, from: alkyl vinyl monomers such as, for example, 2-hydroxyethyl (meth)acrylate, 2-hydroxypropyl (meth)acrylate, 2-ethylhexyl (meth)acrylate, butoxyethyl (meth)acrylate; cyclic vinyl monomers such as, for example, tetrahydrofurfuryl (meth)acrylate; linear or branched alkyl (meth)acrylates such as, for example, methyl (meth)acrylate, ethyl (meth)acrylate, butyl (meth)acrylate, octyl (meth)acrylate, decyl (meth)acrylate, tridecyl (meth)acrylate, stearyl (meth)acrylate, lauryl (meth)acrylate, isodecyl (meth)acrylate), n-hexyl (meth)acrylate; cyclic (meth)acrylates such as, for example, cyclohexyl (meth)acrylate, isobornyl (meth)acrylate; ethoxylated alkyl (meth)acrylates such as, for example, methoxyethyl (meth)acrylate, ethoxyethyl (meth)acrylate, butoxyethyl (meth)acrylate, 2-(2-ethoxy)ethyl (meth)acrylate; dicyclopentenyl (meth)acrylate; diethylene glycol (meth)acrylate; ethoxy-diethylene glycol (meth)acrylate; benzyl (meth)acrylate; polyethylene glycol (meth)acrylate; polypropylene glycol (meth)acrylate; methoxypolyethylene glycol (meth)acrylate; methoxypolypropylene glycol (meth)acrylate; 2-phenoxyethyl (meth)acrylate; phenoxypolyethylene glycol (meth)acrylate; alkylphenoxyethyl (meth)acrylate such as, for example, nonylphenoxyethyl (meth)acrylate; alkylphenoxypolyalkylene glycol (meth)acrylate; 2-hydroxy-3-phenyloxypropyl (meth)-acrylate; tetra-hydrofurfuryloxypropylalkylene glycol (meth)acrylate; dicyclopentenyloxypolyalkylene glycol (meth)acrylate; polyfluoroalkyl (meth)acrylate; or mixtures thereof; or from aromatic vinyl monomers such as, for example, styrene, o-methylstyrene, m-methylstyrene, p-methylstyrene, 2,4-dimethylstyrene, ethylstyrene, p-t-butylstyrene, α-methylstyrene, α-methyl-p-methylstyrene, o-chlorostyrene, m-chlorostyrene, p-chlorostyrene, p-bromostyrene, 2-methyl-1,4-dichlorostyrene, 2,4-dibromo-styrene, vinylnaphthalene, or mixture thereof; or derivatives thereof including styrene monomers containing copolymerizable monomer as a substituent such as, for example, acrylonitrile, maleic anhydride, methyl methacrylate, vinyl acetate, divinylbenzene, or mixtures thereof. Methyl (meth)acrylate or styrene monomers are preferred. Styrene is particularly preferred.

According to one preferred embodiment, the vinyl monomer may be used in an amount of from 0.1% by weight to 99% by weight, preferably of from 0.5% by weight to 90% by weight, with respect to the total weight of the surface-treated vulcanized rubber in a subdivided form and the vinyl monomer.

According to one preferred embodiment, the transition metal compound may be selected, for example, from compounds having the following structural formula (VI):

Mⁿ⁺X′ₙ (VI)

wherein:
Mⁿ⁺ is a metal cation selected from: Cu¹⁺, Cu²⁺, Fe²⁺, Fe³⁺, Ru²⁺, Ru³⁺, Cr²⁺, Cr³⁺, Mo⁰, Mo⁺, Mo²⁺, Mo³⁺, W²⁺, W³⁺, Rh³⁺, Rh⁴⁺, Co⁺, Co²⁺, Re²⁺, Re³⁺, Ni⁰, Ni⁺, Mn³⁺, Mn⁴⁺, V²⁺, V³⁺, Zn⁺, Zn²⁺, Au⁺, Au²⁺, Ag⁺, Ag²⁺, Pd²⁺;
X′ represents a halogen atom such as, for example, chlorine, bromine, iodine, or fluorine; a linear or branched C₁-C₆ alkoxy group; a group selected from: (SO₄)_{1/2}, (PO₄)_{1/3}, (HPO₄)_{1/2}, (H₂PO₄), hexafluorophosphate, methanesulfonate, arylsulfonate such as, for example, benzenesulfonate, toluenesulfonate; SeR₅ group wherein R₅ has the same meanings above defined; CN group; R₉CO₂ group wherein R₉ represents a hydrogen atom, a linear or branched C₁-C₆ alkyl group, preferably a methyl group, said alkyl group being optionally substituted with 1 to 5 halogen atom such as, for example, fluorine, chlorine;
n is the valence of the metal cation and is an integer of from 0 to 7, extremes included.

Preferably, the transition metal compound which is used in the present invention contains metal cation in its lower valent state. More preferably, the transition metal compound is CuBr.

According to a further preferred embodiment, in order to control the vinyl polymer growth onto the surface of the vulcanized rubber in a subdivided form, a mixture of a transition metal compound containing a metal cation in its lower valent state with a transition metal compound containing a metal cation in its higher valent state, may be advantageously used. A mixture of CuBr with CuBr₂ is preferred.

According to one preferred embodiment, the ligand may be selected from compounds having the following structural formulae (VII) or (VIII):

R₁₀-Z-R₁₁ (VII)

R₁₀-Z-(R₁₂-Z)ₘ-R₁₁ (VIII)

wherein:
R₁₀ and R₁₁, which may be identical or different, represent a hydrogen atom; a linear or branched C₁-C₂₀ alkyl group; a C₆-C₁₈ aryl group; a C₅-C₁₈ heterocyclic group; a C(═Y)R₆ group wherein Y and R₆ have the same meanings reported above; a C(═Y)R₇R₈ group wherein Y, R₇ and R₈ have the same meanings reported above; a YC(═Y)R₉ group wherein Y and R₉ have the same meanings reported above; or, R₁₀ and R₁₁ groups considered jointly with the Z substituent to which they are linked, represent a C₅-C₁₈ heterocyclic ring;
Z represents O, S, a NR₁₃ group or a PR₁₃ group, wherein R₁₃ has the same meanings of R₁₀ and R₁₁ reported above;
each of R₁₂ represent, independently, a divalent group selected from: a linear or branched C₂-C₄ alkylene or alkenylene where the covalent bonds to each Z substituents are at vicinal positions (e.g. in a 1,2 arrangement) or at β-positions (e.g. in a 1,3 arrangement); or from a C₃-C₈ cycloalkanediyl or cycloalkenediyl group, an arenediylgroup group, a heterocyclylene group, wherein the covalent bonds to each Z substituents are at the vicinal positions;
m is an integer from 1 to 6, extremes included.

In addition, to the above ligands, each of R₁₀-Z and R₁₁-Z group may form a ring with the R₁₂ group to which the Z substituent is bound to form a linked or fused heterocyclic ring system. Alternatively, when R₁₀ and R₁₁ form an heterocyclic, Z may be a covalent bond (which may be single or double), CH₂, or a 4- to 7-membered ring fused to R₁₀ and/or R₁₁, in addition to the definitions given above for Z. Specific example of ring system are: bipyridine, 4,4′-dimethyl-2,2′-bipyridine, bypirrole, 1,10-phenatroline.

Preferred ligand are: N,N,N′,N″,N″-pentamethyl-diethylenetriamine, imino-bis-propylamine, methylimino-bis-propylamine, or mixtures thereof.

According to one preferred embodiment, the transition metal compound having structural formula (VI) and the ligand having structural formulae (VII) or (VIII) may be used in a molar ratio of from 0.5:1 to 1.5:1, preferably of from 0.7:1 to 1:1.

According to one preferred embodiment, in the case in which a mixture of a transition metal compound containing a metal cation in its lower valent state (for example, CuBr) with a transition metal compound containing a metal cation in its higher valent state (for example, CuBr₂) is used, the transition metal compound containing a metal cation in its lower valent state and the transition metal compound containing a metal cation in its higher valent state may be used in a molar ratio of from 2:1 to 20:1, preferably of from 5:1 to 15:1. In this case, the molar ratio between the transition metal compound having structural formula (VI) and the ligand having structural formulae (VII) or (VIII) is referred to the transition metal compound having a lower valent state.

According to one preferred embodiment, said grafting step may be carried out at a temperature of from 0° C. to 150° C., more preferably of from 60° C. to 110° C., for a time of from 1 hour to 48 hours, more preferably of from 15 hours to 30 hours.

Preferably, said grafting step may be carried out in the absence of solvent (bulk polymerization), for example by absorbing directly the vinyl monomer onto the surface-treated vulcanized rubber. However, when solvent is used, suitable solvents are, for example: ethers (for example, diethyl ether, ethyl propyl ether, dipropyl ether, diethylene glycol dimethyl ether), cyclic ethers (for example tetrahydrofurane, dioxane), aromatic hydrocarbon (for example, benzene, toluene, xylene) halogenated hydrocarbons (for example, 1,2-dichloroethane), or mixtures thereof.

Said grafting step may also be carried out in accordance to other known techniques such as, suspension polymerization, emulsion polymerization, precipitation polymerization.

Generally, said grafting step is continued until the conversion of the vinyl monomer reaches 20% to 100%, preferably 25% to 90%.

After completion of said grafting step, the obtained thermoplastic elastomeric material may be recovered in accordance with any methods known in the art such as, for example, by removing the unreacted monomer, the homopolymer, and the diluent solvent optionally present, by solvent extraction, or by heating under reduced pressure, or by extrusion by means of an extruder designed so as to remove volatile matter. Subsequently, the so obtained thermoplastic elastomeric material may be pelletized or powdered as needed.

Alternatively, the obtained thermoplastic elastomeric material may be recovered by a method such as separation by filtration or centrifugation, washed with water or with inert solvents, dried and subsequently pelletized or powdered as needed.

The pellets or powders may be either packaged for future use or used immediately in a process of forming a manufactured product.

As already reported above, the pellets or powders may be directly formed into manufactured products according to techniques known in the art for thermal processing of thermoplastic resin compositions. For example, compression molding, vacuum molding, injection molding, calendering, casting, extrusion, filament winding, laminating, rotational or slush molding, transfer molding, lay-up or contact molding, stamping, or combinations of these methods, may be used.

Alternatively, as already reported above, the obtained pellets or powder may be added as interface compatibilizing agent to other polymers, preferably to polymers having the same kind of polymeric chains. For example, the obtained thermoplastic elastomeric material in pellets or powder form, may be melt-mixed with polystyrene to be used as a polymer blend, or may be mixed or melt-mixed with a polymer other than polystyrene, said polymer being selected, for example, from: styrene-butadiene rubbers, polyphenylene ether resins, polycarbonates, polyesters, to be used as a polymer blend.

Therefore, according to a further aspect, the present invention also relates to the use of a thermoplastic elastomeric material obtained by means of the process according to the present invention in blends with other polymers.

To the obtained thermoplastic elastomeric material conventional additives such as stabilizers [for example, antioxidants (phenolic antioxidants, phosphoric antioxidants), ultraviolet ray absorber (thermostabilizers)], flame-retardants, lubricants (for example, zinc stearate, calcium stearate, ethylene-bis-stearylamide), mold lubricants or parting agents, antistatic agents, fillers, colorants (for example, titanium oxide, red iron oxide, azo compounds, perylene, phthalocyanine, heterocyclic-series compounds), plasticizers and spreading agents (for example, polyethylene glycol, mineral oil), surface-modifying agents, or mixtures thereof, may be added.

According to a further aspect, the present invention also relates to a manufactured product comprising the thermoplastic elastomeric material above disclosed.

Said thermoplastic elastomeric material may be molded in sheet form and structural form designed and adaptable as packaging structures, housings, support structures, furnitures, molded articles, toys, architectural trims, and the like.

Moreover, said thermoplastic elastomeric material may also be used in order to make, for example, belts such as, for example, conveyor belts, power belts or driving belts; flooring and footpaths which may be used for recreational area, for industrial area, for sport or safety surfaces; flooring tiles; mats such as, for example, anti-static computer mats, automotive floor mats; mounting pads; shock absorbers sheetings; sound barriers; membrane protections; carpet underlay; automotive bumpers; wheel arch liner; seals such as, for example, automotive door or window seals; o-rings; gaskets; watering systems; pipes or hoses materials; flower pots; building blocks; roofing materials; and the like.

The present invention will be further illustrated below by means of a number of preparation examples, which are given for purely indicative purposes and without any limitation of this invention.

### EXAMPLE 1

### Preparation of Surface-Treated Vulcanized Rubber in a Subdivided Form

A vulcanized rubber (cryogenically ground waste rubber from scrap tyres (having an average diameter <0.1 mm (140 mesh)—Applied Cryogenics International AG) was extracted with boiling acetone in order to remove plasticizers, accelerators and other additives usually present in the vulcanized rubber obtained from scrap tyres and was subsequently dried under vacuum until constant weight.

10 g of the obtained vulcanized rubber and 50 ml of an H₂O/acetone solution (9/1 in volume), were added into a 500 ml flask. The mixture was stirred, at room temperature, for 12 hours.

Afterward, 200 ml of an aqueous solution of potassium permanganate (KMnO₄—10% by weight in distilled water) were added dropwise and the mixture was stirred, at room temperature, for 24 hours. After 24 hours the purple colour of the potassium permanganate disappeared indicating the completion of the reaction.

The formed by-product, manganese dioxide (MnO₂), was further oxidized by adding 10 ml (2 ml each time) of a hydrogen peroxide solution (30% in volume) with 1% in volume of sulphuric acid. The obtained solid product was then filtered and washed with water until the filtrate was neutral, then with acetone and finally with diethyl ether. Subsequently, the solid product was dried under vacuum until constant weight: a vulcanized rubber with hydroxy groups on its surface was obtained.

6 ml (48.5 mol) of 2-bromoisobutyrylbromide (BIBB) was added to 50 ml of tetrahydrofurane which was previously distilled over Na/K. The mixture was stirred, at room temperature, for 1 hour, to obtain an homogeneous solution.

2 gr of the vulcanized rubber obtained as above disclosed were added to a solution containing 10 ml (71.7 mol) of triethylamine which was previously distilled over KOH, and the homogeneous solution obtained as above disclosed (6 ml of 2-bromoisobutyrylbromide (BIBB)+50 ml of tetrahydrofurane).

The mixture was kept at reflux temperature for 10 hours, rinsed with ethanol, extracted in a Kumagawa extractor with ethanol, dried under vacuum until constant weight and stored under nitrogen.

### EXAMPLES 2-3

### Comparatives

### Preparation of the Thermoplastic Material Comprising an Elastomeric Phase

A vulcanized rubber (cryogenically ground waste rubber from scrap tyres (having an average diameter <0.1 mm (140 mesh)—Applied Cryogenics International AG) was extracted as disclosed in Example 1.

0.5 g of the extracted vulcanized rubber as such (namely, not surface-treated) were added to a 50 ml glass tube under nitrogen stream and a solution of 9.5 g of styrene which was previously distilled under vacuum, with dibenzoyl peroxide in the following amounts (the amount of dibenzoyl peroxide is expressed as % by moles with respect to the total moles of the vinyl monomer):

### Example 2: 1,

### Example 3: 2,

was then added. The mixture was stirred, at 85° C., for 24 hours.

The obtained thermoplastic elastomeric material was suspended in chloroform, precipitated in methanol and dried under vacuum until constant weight.

The grafting efficiency (Φ) of the styrene was determined as follows.

A sample of 1 g of the obtained thermoplastic elastomeric material was extracted in boiling chloroform for 8 hours in order to extract the ungrafted polystyrene. After the extraction, the thermoplastic elastomeric material was dried under vacuum until constant weight and conditioned at room temperature before weighting. The difference between the weight of the sample before the extraction and the weight of the sample after the extraction corresponds to the weight of the ungrafted polystyrene.

The grafting efficiency (Φ) was determined by means of the following formula:

$$( Φ ) = \frac{( WGV )}{( WTV )} \times 100$$

wherein:
WGV is the weight, expressed in grams (g), of the surface-grafted polystyrene;
WTV is the total weight, expressed in grams (g), of the polystyrene contained in the obtained thermoplastic elastomeric material.

The weight of the surface-grafted polystyrene (WGV) corresponds to the difference between the total weight of the polystyrene (WTV) and the weight of the ungrafted polystyrene which was determined as reported above.

The total weight of polystyrene (WTV), which corresponds to the sum between the weight of the surface-grafted polystyrene and the weight of the ungrafted polystyrene contained in the obtained thermoplastic elastomeric material, was determined by means of a gravimetric analysis by a mass balance. To this purpose the thermoplastic elastomeric material obtained as disclosed above, was suspended in chloroform, precipitated in methanol and dried under vacuum until constant weight and was weighted: the difference between the so obtained weight and the weight of the starting vulcanized rubber in a subdivided form used in order to obtain the corresponding thermoplastic elastomeric material, corresponds to the total weight of the polystyrene (WTV).

The Degree of Grafting (% DG) was determined by means of the following formula:

$$\% DG = \frac{( WAE - WRS )}{( WRS )} \times 100$$

wherein:
WAE is the weight, expressed in grams (g), of the obtained thermoplastic elastomeric material after extraction of the ungrafted polystyrene;
WRS is the weight, expressed in grams (g), of the vulcanized rubber in a subdivided form in the obtained thermoplastic elastomeric material.

The amount of the surface-grafted polystyrene was determined by means of the following formula:

$$\% of surface grafted polystyrene = \frac{( WGV )}{( WAE )} \times 100$$

wherein:
WGV is the weight, expressed in grams (g), of the surface-grafted polystyrene;
WAE is the weight, expressed in grams (g), of the obtained thermoplastic elastomeric material after extraction of the ungrafted polystyrene.

The obtained data are given in Table 1.

### EXAMPLES 4-5

### Preparation of the Thermoplastic Material Comprising an Elastomeric Phase

The surface-treated vulcanized rubbers obtained as disclosed in Example 1 was used.

For comparative purposes, a vulcanized rubber in a subdivided form as such (namely, not surface-treated), was extracted as disclosed in Example 1.

62.7 g (0.437 mmol) of CuBr, 12.5 gr (0.056 mmol) of CuBr₂, 4.75 g of styrene which was previously distilled under vacuum and 103 μl (0.493 mmol) of N,N,N′,N″,N″-pentamethyldiethylenetriamine were added to a Schlenk flask previously degassed, backfilled three times with nitrogen and then kept under nitrogen.

The solution was stirred for 3 hours until CuBr₂ was completely dissolved and the solution turned darker green.

0.5 g of vulcanized rubber were added to the above solution. The mixture was deoxygenated via three cycles of freezing, vacuum evacuating and thawing, and was finally kept under dry nitrogen.

The flask was then placed in an oil bath thermostated at 100° C., under stirring, for 24 hours.

The obtained thermoplastic elastomeric material was suspended in chloroform, precipitated in methanol and dried under vacuum until constant weight.

The total weight of polystyrene, the weight of the ungrafted polystyrene homopolymer, the grafting efficiency (Φ), the Degree of Grafting (% DG) and the amount of the surface-grafted polystyrene, were determined as disclosed above in Examples 2-3.

TABLE 1

| | | WEIGHT OF | | | AMOUNT OF |
|---|---|---|---|---|---|
| | TOTAL | UNGRAFTED | | DEGREE | SURFACE- |
| | WEIGHT OF | POLYSTYRENE | GRAFTING | OF | GRAFTED |
| | POLYSTYRENE | HOMOPOLYMER | EFFICIENCY | GRAFTING | POLYSTYRENE |
| EXAMPLE | (g) | (g) | (Φ) | (% DG) | (%) |
| 2 (*) | 0.83 | 0.54 | 35 | 58 | 36.7 |
| 3 (*) | 0.68 | 0.48 | 29 | 40 | 28.6 |
| 4 (*) | 2.50 | 2.50 | 0 | 0 | 0 |
| 5 | 3.77 | 1.70 | 55 | 414 | 80.5 |

(*): comparative

Examples 2-4: vulcanized rubber (cryogenically ground waste rubber from scrap tyres (average diameter <0.1 mm (140 mesh)—Applied Cryogenics International AG);
Example 5: surface-treated vulcanized rubber from Example 1.

The data above reported clearly show that the process according to the present invention (Example 5), even starting from a lower amount of styrene monomer with respect to comparative Examples 2-3, allow to increase the amount of the surface-grafted polystyrene with respect to the process of the prior art (free-radical polymerization in the presence of a not-surface treated vulcanized rubber—Examples 2-3). Moreover, the data above reported show that the use of a not-surface treated vulcanized rubber (Example 4), even in the presence of both a transition metal compound and a ligand, does not allow to obtain the surface-grafting of the polystyrene.

1-66. (canceled)

67. A process for manufacturing a thermoplastic elastomeric material, comprising the following steps:
surface treating a vulcanized rubber in a subdivided form in order to provide radically transferable atoms or groups on its surface; and
grafting at least one vinyl monomer to said surface-treated vulcanized rubber in the presence of at least one transition metal compound and at least one ligand so as to obtain a vinyl polymer grafted onto the surface of said vulcanized rubber in a subdivided form.

68. The process according to claim 67, wherein the grafting efficiency of said vinyl polymer onto the surface of said vulcanized rubber is not lower than 40%.

69. The process according to claim 68, wherein the grafting efficiency of said vinyl polymer onto the surface of said vulcanized rubber is 45% to 60%.

70. The process according to claim 68, wherein the grafting efficiency of said vinyl polymer onto the surface of said vulcanized rubber is 50% to 80%.

71. The process according to claim 67, wherein the degree of grafting of said vinyl polymer onto the surface of said vulcanized rubber in a subdivided form is not lower than 150%.

72. The process according to claim 71, wherein the degree of grafting of said vinyl polymer onto the surface of said vulcanized rubber in a subdivided form is 160% to 600%.

73. The process according to claim 71, wherein the degree of grafting of said vinyl polymer onto the surface of said vulcanized rubber in a subdivided form is 180% to 800%.

74. The process according to claim 67, wherein said vinyl polymer is grafted onto the surface of said vulcanized rubber in a subdivided form in an amount not lower than 60% by weight with respect to the total weight of the surface-grafted vinyl polymer and the vulcanized rubber in a subdivided form.

75. The process according to claim 74, wherein said vinyl polymer is grafted onto the surface of said vulcanized rubber in a subdivided form in an amount not lower than 70% by weight with respect to the total weight of the surface-grafted vinyl polymer and the vulcanized rubber in a subdivided form.

76. The process according to claim 67, wherein the vulcanized rubber in a subdivided form is in the form of powder or granules having a particle size not higher than 10 mm.

77. The process according to claim 67, wherein the vulcanized rubber in a subdivided form is in the form of powder or granules having a particle size not higher than 0.5 mm.

78. The process according to claim 77, wherein the vulcanized rubber in a subdivided form is in the form of powder or granules having a particle size not higher than 0.2 mm.

79. The process according to claim 78, wherein the vulcanized rubber in a subdivided form is in the form of powder or granules having a article size not higher than 0.1 mm.

80. The process according to claim 67 wherein the vulcanized rubber in a subdivided form comprises at least one crosslinked diene elastomeric polymer or copolymer of natural origin or obtained by solution polymerization, emulsion polymerization or gas-phase polymerization of one or more conjugated diolefins, optionally blended with at least one comonomer selected from monovinylarenas and/or polar comonomers in an amount not greater than 60% by weight.

81. The process according to claim 80, wherein the crosslinked diene elastomeric polymer or copolymer is selected from: cis-1,4-polyisoprene, 3,4-polyisoprene, polyutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

82. The process according to claim 67, wherein the vulcanized rubber in a subdivided form further comprises at least one crosslinked elastomeric polymer of one or more monolefins with an olefinic comonomer or derivatives thereof.

83. The process according to claim 82, wherein the crosslinked elastomeric polymer is selected from: ethylene/propylene copolymers or ethylene/propylene/diene copolymers; polyisobutene; butyl rubbers; halobutyl rubbers, chlorobutyl rubbers, or bromobutyl rubbers; or mixtures thereof.

84. The process according to claim 67, wherein said surface treating step is carried out by dispersing said vulcanized rubber in a subdivided form in a mixture comprising at least one organic solvent, at least one tertiary amine and at least one compound having the following structural formula (I): 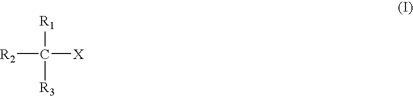
wherein:
X represents a halogen atom, chlorine, bromine, iodine, or fluorine; an OR₄ group wherein R₄ represents a linear or branched C₁-C₂₀ alkyl group, a linear or branched C₂-C₂₀ alkenyl group, a linear or branched C₂-C₂₀ alkynyl group, a phenyl group, said phenyl group being optionally substituted by 1 to 5 halogen atoms or by 1 to 5 linear or branched C₁-C₄ alkyl groups; a group selected from: SR₅, SeR₅, OC(═O)R₅, OP(═O)R₅, OP(═O) (OR₅)₂, OP(═O)OR₅, O—N(R₅)₂, wherein R₅ represents a C₆-C₁₈ aryl group; a C₇-C₂₀ arylalkyl or alkylaryl group, methylphenyl, ethylphenyl, phenylethyl; a C₇-C₂₀ arylalkoxy or alkoxyaryl group; a linear or branched C₁-C₂₀ alkyl group; a N(R₄)₂ group wherein the two R₄ groups considered jointly with the nitrogen atom to which they are linked, represent a C₅-C₁₈ heterocyclic ring; and
R₁, R₂, and R₃, which may be identical or different, represent a hydrogen atom; a linear or branched C₁-C₂₀ alkyl group; a C₃-C₈ cycloalkyl group; a C(═Y)R₆ group, wherein Y represents an oxygen atom or a NR₉ group wherein R₉ represents a linear or branched C₁-C₂₀ alkyl group, a C₇-C₂₀ arylalkyl or alkylaryl group and R₆ represents a linear or branched C₁-C₂₀ alkyl group, a linear or branched C₁-C₂₀ alkoxy group, a C₇-C₂₀ arylalkoxy or alkoxyaryl group, a heterocyclyloxy group; a halogen atom, chlorine, bromine, iodine, or fluorine; or a C═(Y)NR₇R₈ group, wherein Y has the same meanings reported above and R₇ and R₈, which may be identical or different, represent a hydrogen atom, a linear or branched C₁-C₂₀ alkyl group, or R₇ and R₈ groups considered jointly with the nitrogen atom to which they are linked, represent a C₅-C₁₈ heterocyclic ring; a linear or branched C₂-C₂₀ alkenyl or alkynyl group; an oxiranyl group; a glycydyl group; a C₆-C₁₈ aryl group; and a C₇-C₂₀ arylalkyl or alkylaryl group.

85. The process according to claim 84, wherein in the compound having structural formula (I), X is a chlorine atom or a bromine atom; R₂ is a C(═Y)R₆ group, wherein Y is an oxygen atom and R₆ is a bromine atom or a linear or branched C₁-C₂₀ alkoxy group; R₂ and R₃, which may be identical or different, are a linear or branched C₁-C₂₀ alkyl group.

86. The process according to claim 84, wherein the compound having structural formula (I) is selected from: 1-phenylethylchloride, 1-phenylethylbromide, methyl 2-chloropropionate, ethyl 2-chloropropionate, methyl 2-bromopropionate, ethyl 2-bromoisobutyrate, α,α′-dichloroxylene, α,α′-dibromoxylene, hexakis (α-bromomethyl)benzene, 2-bromoisobutyryl bromide, ethyl-2-bromopropionate, or mixtures thereof.

87. The process according to claim 86, wherein the compound having structural formula (I) is 2-bromoisobutyryl bromide or ethyl-2-bromopropionate.

88. The process according to claim 84, wherein the organic solvent is selected from: ketones, acetone; alcohols, ethanol, methanol; ethers, tetrahydrofurane, dioxane, diethyl ether; or mixtures thereof.

89. The process according to claim 84, wherein the tertiary amine is selected from: trimethylamine, triethylamine, tripropylamine, ethyleneimine, pyrrolidine, N,N-dimethylaminepyridine, or mixtures thereof.

90. The process according to claim 89, wherein the tertiary amine is triethylamine.

91. The process according to claim 84 wherein the compound having structural formula (I) comprises 0.1 ml to 10 ml with respect to 1 g of the vulcanized rubber in a subdivided form.

92. The process according to claim 91, wherein the compound having structural formula (I), comprises 1 ml to 5 ml with respect to 1 g of the vulcanized rubber in a subdivided form.

93. The process according to claim 84, wherein the solvent comprises 10 ml to 100 ml with respect to 1 g of the vulcanized rubber in a subdivided form.

94. The process according to claim 93, wherein the solvent comprises 40 ml to 70 ml with respect to 1 g of the vulcanized rubber in a subdivided form.

95. The process according to claim 84, wherein the tertiary amine comprises 1 ml to 10 ml with respect to 1 g of the vulcanized rubber in a subdivided form.

96. The process according to claim 95, wherein the tertiary amine comprises 3 ml to 7 ml with respect 1 g of the vulcanized rubber in a subdivided form.

97. The process according to claim 84 wherein said surface treating step is carried out at a temperature of 40° C. to 120° C.

98. The process according to claim 97, wherein said surface treating step is carried out at a temperature of 60° C. to 100° C.

99. The process according to claim 84, wherein said surface treating step is carried out for 1 hour to 24 hours.

100. The process according to claim 99, wherein said surface treating step is carried out for 5 hours to 15 hours.

101. The process according to claim 67, wherein said vulcanized rubber in a subdivided form is subjected, before said surface treating step, to an additional surface treating step in order to provide hydroxy groups and/or mercapto groups on said surface.

102. The process according to claim 101, wherein said additional surface treating step in order to provide hydroxy groups on said surface is carried out by dispersing said vulcanized rubber in a subdivided form in a mixture comprising water and a organic solvent with at least one oxidizing agent.

103. The process according to claim 101, wherein said additional surface treating step in order to provide hydroxy groups on said surface is carried out by reacting the vulcanized rubber in a subdivided form with a thio-glycerol having the following structural formula (II): 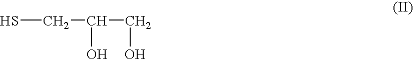
in the presence of at least one free radical initiator.

104. The process according to claim 102, wherein said surface treated vulcanized rubber in a subdivided form is treated with at least one silane coupling agent in order to provide mercapto groups on said surface.

105. The process according to claim 101, wherein the additional surface treating step in order to provide mercapto groups on said surface is carried out by reacting the vulcanized rubber in a subdivided form with at least one thio-acid having the following structural formula (V):
R′₁—C(═O)—SH (V)
wherein R′₁ is selected from alkyl, aryl, alkylaryl or arylakyl groups, in the presence of at least one free radical initiator.

106. The process according to claim 67, wherein said vinyl polymer is selected from: alkyl vinyl monomers, 2-hydroxyethyl (meth)acrylate, 2-hydroxypropyl (meth)acrylate, 2-ethylhexyl (meth)acrylate, butoxyethyl (meth)acrylate; cyclic vinyl monomers, tetrahydrofurfuryl (meth)acrylate, linear or branched alkyl (meth)acrylates, methyl (meth)acrylate, ethyl (meth)acrylate, butyl (meth)acrylate, octyl (meth)acrylate, decyl (meth)acrylate, tridecyl (meth)acrylate, stearyl (meth)acrylate, lauryl (meth)acrylate, isodecyl (meth)acrylate, n-hexyl (meth)acrylate; cyclic (meth)acrylate, cyclohexyl (meth)acrylate, isobornyl (meth)acrylate; ethoxylated alkyl (meth)acrylates, methoxyethyl (meth)acrylate, ethoxyethyl (meth)acrylate, butoxyethyl (meth)acrylate, 2-(2-ethoxy)ethyl (meth)acrylate; dicyclopentenyl (meth)acrylate; diethylene glycol (meth)acrylate; ethoxydiethylene glycol (meth)acrylate; benzyl (meth)acrylate; polyethylene glycol (meth)acrylate; polypropylene glycol (meth)acrylate; methoxypolyethylene glycol (meth)acrylate; methoxypolypropylene glycol (meth)acrylate; 2-phenoxyethyl (meth)acrylate; phenoxypolyethylene glycol (meth)acrylate; alkylphenoxyethyl (meth)acrylate; nonyl-phenoxyethyl (meth)acrylate; alkylphenoxypolyalkylene glycol (meth)acrylate; 2-hydroxy-3-phenyloxypropyl (meth)acrylate; tetra-hydrofurfuryloxypropylalkylene glycol (meth)acrylate; dicicyclopentenyloxypolyalkylene glycol (meth)acrylate; polyfluoroalkyl (meth)acrylate; or mixtures thereof, or from aromatic vinyl monomers, styrene, o-methylstyrene, m-methylstyrene, p-methylstyrene, 2,4-dimethylstyrene, ethylstyrene, p-t-butylstyrene, α-methylstyrene, α-methyl-p-methylstyrene, o-chlorostyrene, m-chlorostyrene, p-chlorostyrene, p-bromostyrene, 2-methyl-1,4-dichlorostyrene, 2,4-dibromostyrene, vinylnaphthalene, or mixture thereof; or derivatives thereof, comprising styrene monomers containing copolymerizable monomer as a substituent, acrylonitrile, maleic anhydride, methyl methacrylate, vinyl acetate, divinylbenzene, or mixtures thereof.

107. The process according to claim 106, wherein said vinyl monomer is selected from methyl (meth)acrylate or styrene monomers.

108. The process according to claim 107, wherein said vinyl monomer is styrene.

109. The process according to claim 67, wherein the vinyl monomer comprises 0.1% by weight to 99% by weight with respect to the total weight of the surface-treated vulcanized rubber in a subdivided form and the vinyl monomer.

110. The process according to claim 109, wherein the vinyl monomer comprises 0.5% by weight to 90% by weight with respect to the total weight of the surface-treated vulcanized rubber in a subdivided form and the vinyl monomer.

111. The process according to claim 67, wherein said transition metal compound is selected from compounds having the following structural formula (VI):
Mⁿ⁺X′ₙ (VI)
wherein:
Mⁿ⁺ is a metal cation selected from: Cu¹⁺, Cu²⁺, Fe²⁺, Fe³⁺, Ru²⁺, Ru³⁺, Cr²⁺, Cr³⁺, Mo⁰, Mo⁺, Mo²⁺, Mo³⁺, W²⁺, W³⁺, Rh³⁺, Rh⁴⁺, Co⁴, Co²⁺, Re²⁺, Re³⁺, Ni⁰, Ni⁺, Mn³⁺, Mn⁴⁺, V²⁺, V³⁺, Zn⁺, Zn²⁺, Au⁺, Au²⁺, Ag⁺, Ag²⁺, and Pd²⁺
X′ represents a halogen atom, chlorine, bromine, iodine, or flourine; a linear or branched C₁-C₆ alkoxy group; a group selected from: (SO₄)_{1/2}, (PO₄)_{1/3}, (HPO₄)_{1/2}, (H₂PO₄), hexafluorophosphate, methanesulfonate, arylsulfonate, benzenesulfonate, toleunesulfonate; SeR₅ group, wherein R₅ has the same meanings above defined, CN group; R₉CO₂ group, wherein R₉ represents a hydrogen atom, a linear or branched C₁-C₆ alkyl group, said alkyl group being optionally substituted with 1 to 5 halogen atoms fluorine, and chlorine; and
n is the valence of the metal cation and is an integer of 0 to 7.

112. The process according to claim 111, wherein said transition metal compound comprises metal cation in its lower valent state.

113. The process according to claim 111, wherein said transition metal compound is CuBr.

114. The process according to claim 111, wherein said transition metal compound is a mixture of a transition metal compound containing a metal cation in its lower valent state with a transition metal compound containing a metal cation in its higher valent state.

115. The process according to claim 114, wherein said mixture is a mixture of CuBr with CuBr₂.

116. The process according to claim 114, wherein the transition metal compound containing a metal cation in its lower valent state and the transition metal compound containing a metal cation in its higher valent state comprises a molar ratio of 2:1 to 20:1.

117. The process according to claim 116, wherein the transition metal compound containing a metal cation in its lower valent state and the transition metal compound containing a metal cation in its higher valent state comprises a molar ratio of 5:1 to 15:1.

118. The process according to claim 67, wherein said ligand is selected from compounds having the following structural formulae (VII) or VIII):
R₁₀-Z-R₁₁ (VII)
R₁₀-Z-(R₁₂-Z)ₘ-R₁₁ (VIII)
wherein:
R₁₀ and R₁₁, which may be identical or different represent a hydrogen atom; a linear or branched C₁-C₂₀ alkyl group; a C₆-C₁₈ aryl group; a C₅-C₁₈ heterocyclic group, a C(═Y)R₆ group, wherein Y and R₆ have the same meanings reported above; a C(═Y)R₇R₈ group wherein Y, R₇ and R₈ have the same meanings reported above; a YC(═Y)R₉ group, wherein Y and R₉ have the same meanings reported above; or, R₁₀ and R₁₁ groups considered jointly with the Z substituent to which they are linked, represent a C₅-C₁₈ heterocyclic ring;
Z represents O, S, a NR₁₃ group or a PR₁₃ group, wherein R₁₃ has the same meanings of R₁₀ and R₁₁ reported above;
each of R₁₂ represents, independently, a divalent group selected from: a linear or branched C₂-C₄ alkylene or alkenylene where covalent bonds to each z substituent are at vicinal positions, in a 1,2 arrangement, or at β-positions, in a 1,3 arrangement; or from a C₃-C₈ cycloalkanediyl or cycloalkenediyl group, an arenediylgrup group, a heterocyclylene group, wherein the covalent bonds to each Z substituent are at the vicinal position; and
m is an integer of 1 to 6.

119. The process according to claim 118, wherein said ligand is selected from: N,N,N′,N″,N″-pentamethyldiethylene-triamine, imino-bis-propylamine, methylimino-bis-propylamine, or mixtures thereof.

120. The process according to claim 67 wherein said transition metal compound having structural formula (VI) and said ligand having structural formulae (VII) or (VIII) are in a molar ratio of 0.5:1 to 1.5:1.

121. The process according to claim 120, wherein said transition metal compound having structural formula (VI) and said ligand having structural formulae (VII) or (VIII) are in a molar ratio of 0.7:1 to 1:1.

122. The process according to claim 67, wherein said grafting step is carried out at 0° C. to 150° C.

123. The process according to claim 122, wherein said grafting step is carried out at 60° C. to 110° C.

124. The process according to claim 67, wherein said grafting step is carried out for 1 hour to 48 hours.

125. The process according to claim 124, wherein said grafting step is carried out for 15 hours to 30 hours.

126. A thermoplastic elastomeric material comprising a vulcanized rubber in a subdivided form surface-grafted with at least one vinyl polymer obtainable by means of a process for manufacturing a thermoplastic elastomeric material, comprising the following steps:
surface treating a vulcanized rubber in a subdivided form in order to provide radically transferable atoms or groups on the surface; and
grafting at least one vinyl monomer to said surface-treated vulcanized rubber in the presence of at least one transition metal compound and at least one ligand so as to obtain a vinyl polymer grafted onto the surface of said vulcanized rubber in a subdivided form.

127. An interface compatibilizing agent comprising a thermoplastic elastomeric material blend with other polymers, said thermoplastic elastomeric polymer obtained by a process for manufacturing a thermoplastic elastomeric material, comprising the following steps:
surface treating a vulcanized rubber in a subdivided form in order to provide radically transferable atoms or groups on its surface; and
grafting at least one vinyl monomer to said surface-treated vulcanized rubber in the presence of at least one transition metal compound and at least one ligand so as to obtain a vinyl polymer grafted onto the surface of said vulcanized rubber in a subdivided form.

128. The interface compatibilizing agent according to claim 127, wherein said other polymers are selected from: polystyrene, styrene-butadiene rubbers, polyphenylene ether resins, polycarbonates, and polyesters.

129. A manufactured product obtained by molding a thermoplastic elastomeric material obtained by a process for manufacturing a thermoplastic elastomeric material, comprising the following steps:
surface treating a vulcanized rubber in a subdivided form in order to provide radically transferable atoms or groups on its surface; and
grafting at least one vinyl monomer to said surface-treated vulcanized rubber in the presence of at least one transition metal compound and at least one ligand so as to obtain a vinyl polymer grafted onto the surface of said vulcanized rubber in a subdivided form.

130. A manufactured product comprising a thermoplastic elastomeric material according to claim 127.

131. The manufactured product according to claim 129 comprising packaging structures, housings, support structures, furniture, molded articles, toys, or architectural trims.

132. The manufactured product according to claim 129 comprising belts, flooring and footpaths, flooring tiles; mats, shock absorber sheetings; sound barriers; membrane protections; carpet underlay; automotive bumpers; wheel arch liner; seals; o-rings; gaskets; watering systems; pipe or hose materials; flower pots; building blocks; roofing materials; or geomembranes.
